(19) United States
(12) Patent Application Publication
(10) Pub. No.: US 2026/0326846 A1
(43) Pub. Date: Oct. 22, 2026

(54) KICKSTAND MECHANISM AND VEHICLE

(71) Applicant: Ninebot (Shenzhen) Tech Co., Ltd., Shenzhen (CN)

(72) Inventors: Wei LI, Shenzhen (CN); Yubao XIE, Shenzhen (CN)

(21) Appl. No.: 19/647,121

(22) Filed: Apr. 14, 2026

(30) Foreign Application Priority Data
Apr. 21, 2025 (CN) 2025207619389

(51) Int. Cl. B62H 1/02

(52) U.S. Cl. CPC B62H 1/02

(57) ABSTRACT

A kickstand mechanism and a vehicle are provided. The kickstand mechanism includes a kickstand base, a support component, a locking component and an elastic piece. The support component is rotatably connected with the kickstand base and has a support position and a retracted position, and the support component includes a first engaging portion and a second engaging portion. The locking component is rotatably connected with the kickstand base. In the support position, the locking component is engaged with the first engaging portion, and in the retracted position, the locking component is engaged with the second engaging portion. When the support component is switched from the retracted position to the support position, the elastic piece acts on the support component and the locking component and is configured to keep the locking component engaged with the first engaging portion or the second engaging portion.

### CROSS-REFERENCE TO RELATED APPLICATION

The present disclosure is based on and claims the benefit of priority to Chinese application No. 202520761938.9, filed on Apr. 21, 2025, the contents of which are incorporated herein by reference in their entireties for all purposes.

### FIELD

The present disclosure relates to the field of vehicle kickstand technology, and specifically to a kickstand mechanism and a vehicle.

### BACKGROUND

A kickstand is a common structure on a vehicle such as an electric two-wheeler and an electric bicycle, and primarily used to support the vehicle when the vehicle is not in use and prevent the vehicle from tipping over. However, the kickstand in the related art suffers from problems such as being difficult to operate, having poor support reliability, and having a complex structure.

### SUMMARY

Embodiments of the present disclosure provide a kickstand mechanism for a vehicle, which includes: a kickstand base configured to be connected to a vehicle frame of the vehicle; a support component rotatably connected to the kickstand base and having a support position where the support component bears against the ground and a retracted position where the support component is away from the ground, wherein the support component comprises a first engaging portion and a second engaging portion; a locking component rotatably connected to the kickstand base, where in the support position, the locking component is engaged with the first engaging portion; and in the retracted position, the locking component is engaged with the second engaging portion, where the locking component is configured to slide along a surface of the support component and switch from the second engaging portion to the first engaging portion when the support component switches from the retracted position to the support position; and an elastic member acting on the support component and the locking component, and configured to keep the locking component engaged with the first engaging portion or the second engaging portion, where the elastic member is further configured to drive the support component to switch from the support position to the retracted position when the locking component is disengaged from the first engaging portion.

Embodiments of the present disclosure provide a vehicle, which includes a vehicle frame and a kickstand mechanism. The kickstand mechanism includes: a kickstand base connected to the vehicle frame; a support component rotatably connected to the kickstand base and having a support position where the support component bears against the ground and a retracted position where the support component is away from the ground, wherein the support component comprises a first engaging portion and a second engaging portion; a locking component rotatably connected to the kickstand base, where in the support position, the locking component is engaged with the first engaging portion; and in the retracted position, the locking component is engaged with the second engaging portion, where the locking component is configured to slide along a surface of the support component and switch from the second engaging portion to the first engaging portion when the support component switches from the retracted position to the support position; and an elastic member acting on the support component and the locking component, and configured to keep the locking component engaged with the first engaging portion or the second engaging portion, where the elastic member is further configured to drive the support component to switch from the support position to the retracted position when the locking component is disengaged from the first engaging portion.

### BRIEF DESCRIPTION OF THE DRAWINGS

FIG. 1 is a perspective view of an overall kickstand mechanism according to an embodiment of the present disclosure.

FIG. 2 is a schematic view of a support component in a support position according to an embodiment of the present disclosure.

FIG. 3 is a schematic view of a support component in a retracted position according to an embodiment of the present disclosure.

FIG. 4 is an exploded view of a kickstand mechanism according to an embodiment of the present disclosure.

### DETAILED DESCRIPTION

The embodiments of the present disclosure are described in detail below, examples of which are shown in the accompanying drawings. The embodiments described below with reference to the accompanying drawings are illustrative and intended to explain the present disclosure, and should not be construed as limiting the present disclosure.

As shown in FIG. 1, a kickstand mechanism according to embodiments of the present disclosure includes a kickstand base 1, a support component 2, a locking component 3, and an elastic member 4.

The kickstand base 1 is used to be connected to a vehicle frame. For example, as shown in FIG. 1, the kickstand base 1 may be a U-shaped structure and may be located at a top of the kickstand mechanism. An opening of the kickstand base 1 may be arranged to face downwards. During mounting, the kickstand base 1 may be connected and fixed to the vehicle frame by fasteners such as screws, thereby realizing the mounting and fixation of the whole kickstand mechanism.

The support component 2 is rotatably connected to the kickstand base 1 and has a support position where the support component 2 bears against the ground and a retracted position where the support component 2 is away from (i.e., not bearing against) the ground. The support component 2 includes a first engaging portion 21 and a second engaging portion 22.

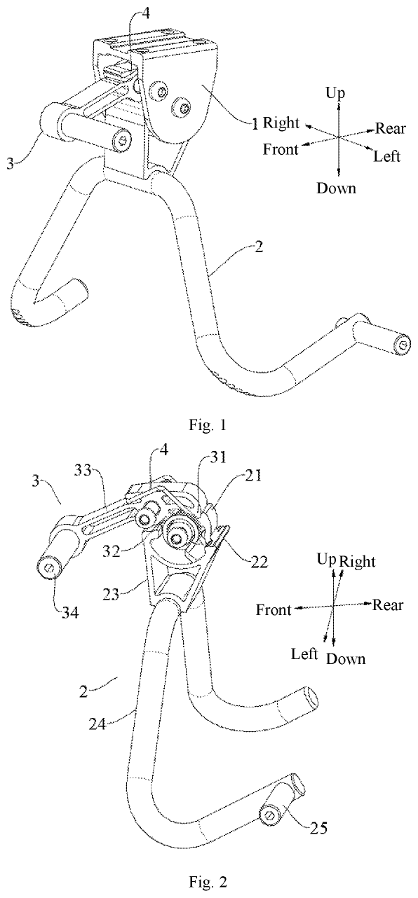

For example, as shown in FIG. 1, a top end of the support component 2 may be rotatably assembled in the kickstand base 1, and the support component 2 may swing in a front-rear direction. When the support component 2 swings forward, it may swing to a substantively vertical position, as shown in FIG. 2. In this case, a bottom side of the support component 2 may be in close contact with and abut against the ground. The upright support component 2 may support the vehicle frame, etc., thus facilitating the standing of the vehicle when it is not in use.

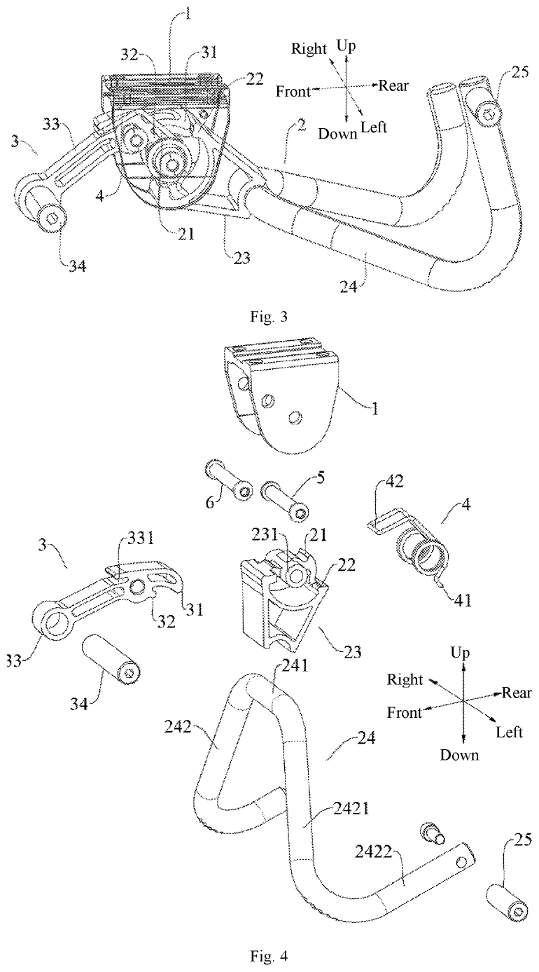

When the support component 2 swings backward, it may swing to a substantively horizontal state, as shown in FIG. 3. In this case, the whole support component 2 may be separated from the ground, and wheels of a vehicle may be in contact with the ground, thus allowing the vehicle to be ridden or driven.

As shown in FIGS. 2 and 3, the top end of the support component 2 has two grooves. Openings of the two grooves are arranged in the same orientation. The two grooves may be arranged at intervals in a circumferential direction of a rotational assembled joint of the support component 2 and the kickstand base 1, and the two grooves serve as the first engaging portion 21 and the second engaging portion 22, respectively.

The locking component 3 is rotatably connected to the kickstand base 1. In the support position, the locking component 3 is engaged with the first engaging portion 21, and in the retracted position, the locking component 3 is engaged with the second engaging portion 22. For example, as shown in FIG. 1, a portion of the locking component 3 may be rotatably assembled in the kickstand base 1, and an end of the locking component 3 may be provided with an engaging projection or other structures.

As shown in FIG. 2, when the support component 2 is switched to the support position, the locking component 3 may be engaged with the first engaging portion 21, thereby locking the support component 2 in the support position. As shown in FIG. 3, when the support component 2 is switched to the retracted position, the locking component may be engaged with the second engaging portion 22, thereby locking the support component 2 in the retracted position.

When the support component 2 switches from the retracted position to the support position, the locking component 3 slides along a surface of the support component 2 and switches from the second engaging portion 22 to the first engaging portion 21. Specifically, when it is necessary to switch the support component 2 from the retracted position to the support position, the support component 2 may be driven to swing forward and downward by stepping on the support component 2. During the swinging process, the locking component 3 may swing adaptively under the action of the support component 2, and the engaging projection of the locking component 3 may move along the surface of the support component 2, so that the engaging projection of the locking component 3 may automatically switch from the second engaging portion 22 to the first engaging portion 21. This facilitates the switching of the support component 2 from the retracted position to the support position.

The elastic member 4 acts on the support component 2 and the locking component 3 and is used to keep the locking component 3 engaged with the first engaging portion 21 or the second engaging portion 22. For example, the elastic member 4 may be a structural member with elastic potential energy, such as a torsion spring. The elastic member 4 may be assembled on both the support component 2 and the locking component 3. An elastic force of the elastic member 4 may be applied to both the support component 2 and the locking component 3, so that the support component 2 and the locking component 3 may be in close contact with and press against each other. This allows the engaging projection of the locking component 3 to be held in a position where the engaging projection of the locking component 3 is inserted into the first engaging portion 21 or the second engaging portion 22, thereby ensuring the structural stability of the support component 2 in the support position and the retracted position.

The elastic member 4 is further used to drive the support component 2 to switch from the support position to the retracted position when the locking component 3 is disengaged from the first engaging portion 21. Specifically, when it is necessary to switch the support component 2 from the support position to the retracted position, the locking component 3 may be driven to rotate first. In this case, the engaging projection of the locking component 3 may be separated from the first engaging portion 21. Due to the elastic force applied by the elastic member 4, the support component 2 may swing automatically from the support position to the retracted position. This facilitates the switching of the support component 2 from the support position to the retracted position.

In the kickstand mechanism according to the embodiments of the present disclosure, a user may drive the support component 2 to rotate by stepping on it, when switching it to the support position. At this time, the support component 2 serves as a lever, thus facilitating upward prying of the vehicle frame, etc., and thus saving effort. When switching the support component 2 to the retracted position, the user simply presses down on the locking component 3. Under the action of the elastic member 4, the support component 2 may automatically switch to the retracted position, thus improving overall operational convenience.

Further, through the combined action of the first engaging portion 21, the second engaging portion 22, and the elastic member 4, the support component 2 may be locked in the support position or the retracted position, thus ensuring the structural stability of the support component 2 in the support position and the retracted position, and realizing the self-locking function.

In some embodiments, as shown in FIG. 4, the locking component 3 includes a first engaging projection 31, and the first engaging projection 31 may be integrally formed on the end of the locking component 3. The first engaging projection 31 may be a tongue-shaped structure.

In the support position, as shown in FIG. 2, the first engaging projection 31 is engaged with the first engaging portion 21, thus ensuring the structural stability of the support component 2 in the support position. In the retracted position, as shown in FIG. 3, the first engaging projection 31 is engaged with the second engaging portion 22, thus ensuring the structural stability of the support component 2 in the retracted position.

In some embodiments, the locking component 3 includes a second engaging projection 32, and the first engaging projection 31 and the second engaging projection 32 are arranged at intervals. In the support position, the second engaging projection 32 is disengaged, and in the retracted position, the second engaging projection 32 is engaged with the first engaging portion 21.

For example, as shown in FIG. 4, the second engaging projection 32 may be integrally formed on the locking component 3. The second engaging projection 32 may also be a tongue-shaped structure. A portion of the locking component 3 may generally extend along the front-rear direction. The first engaging projection 31 may be located at a rear end of this portion of the locking component 3, and the second engaging projection 32 may be located in front of the first engaging projection 31 and spaced apart from the first engaging projection 31.

When the support component 2 is switched to the support position, as shown in FIG. 2, only the first engaging projection 31 is engaged with the first engaging portion 21, and the second engaging projection 32 and the second engaging portion 22 are both in an unengaged state.

When the support component 2 is switched to the retracted position, as shown in FIG. 3, the first engaging projection 31 is engaged with the second engaging projection 22, and the second engaging projection 32 is engaged with the first engaging projection 21. Through the respective engagement of the two engaging projections and the two engaging portions, the stability of the support component 2 in the retracted position is fully guaranteed.

In some embodiments, the support component 2 includes a seat 23 and a kickstand bracket 24. The seat 23 is rotatably assembled with the kickstand base 1. The first engaging portion 21 and the second engaging portion 22 are both arranged on the seat 23. The kickstand bracket 24 is connected to the seat 23.

For example, as shown in FIG. 4, the seat 23 may be a block structure, and the kickstand bracket 24 may be formed by bending a cylindrical tube. A receiving groove may be formed on a bottom side of the seat 23, and a portion of the kickstand bracket 24 may be received in the receiving groove and welded to the seat 23. The seat 23 may be assembled in the kickstand base 1, and the seat 23 may swing freely in the kickstand base 1. The first engaging portion 21 and the second engaging portion 22 may both be located on a top side of the seat 23. The multi-piece design of the support component 2 facilitates its processing.

In some embodiments, the kickstand bracket 24 includes a middle section 241 and two support sections 242. The middle section 241 is connected to the seat 23 and is connected between the two support sections 242. The two support sections 242 are arranged opposite to each other with respect to the middle section 241. Each support section 242 includes a first sub-section 2421 and a second sub-section 2422 arranged at an angle relative to each other. The first sub-section 2421 is connected between the middle section 241 and the second sub-section 2422.

For example, as shown in FIG. 4, the overall structure of the kickstand bracket 24 may be substantively symmetrical in a left-right direction. The middle section 241 may be located at a top of the kickstand bracket 24, and the middle section 241 may extend in the left-right direction. The two support sections 242 may be connected to left and right ends of the middle section 241, respectively. The two support sections 242 may be arranged opposite to each other in the left-right direction, and both support sections 242 may be V-shaped structures, that is, each support section 242 may include the first sub-section 2421 and the second sub-section 2422 with different extension directions. The middle section 241 is connected between the two first sub-sections 2421.

When the support component 2 is switched to the support position, as shown in FIG. 2, a corner formed by the first sub-section 2421 and the second sub-section 2422 of each support section 242 may be in close contact with the ground, thus meeting the use requirements of support. When the support component 2 is switched to the retracted position, as shown in FIG. 3, the two first sub-sections 2421 may be switched to a substantively horizontal position, and the two second sub-sections 2422 may extend upward, thus allowing the support component 2 to be out of contact with the ground.

It should be noted that since each support section 242 includes the first sub-section 2421 and the second sub-section 2422, the second sub-section 2422 is tilted upward and rearward when in the retracted position. In this way, when the second sub-section 2422 is stepped on, the second sub-section 2422 may act as a lever, so that the vehicle frame may be lifted with a small force, and this also makes it easy for the support component 2 to switch from the retracted position to the support position, thus saving effort.

In some embodiments, the support component 2 includes a stepping shaft 25, and the stepping shaft 25 is mounted on the second sub-section 2422 of one support section 242, is located on an outer side of the kickstand bracket 24, and extends along a direction in which the two support sections 242 are arranged opposite to each other.

For example, as shown in FIG. 4, the stepping shaft 25 may be a cylindrical shaft. The stepping shaft 25 may be mounted on a free end of the second sub-section 2422 by a fastener such as a bolt, and the stepping shaft 25 may generally extend in the left-right direction. In use, the user may drive the support component 2 to rotate by stepping on the stepping shaft 25, thereby facilitating the switching of the support component 2 from the retracted position to the support position.

In some embodiments, the seat 23 includes a tube 231, the seat 23 is rotatably assembled with the kickstand base 1 via a first shaft 5, and the first shaft 5 is assembled in the tube 231. The elastic member 4 is sleeved on an outer periphery of the tube 231. The elastic member 4 includes a first abutting end 41 and a second abutting end 42. The first abutting end 41 abuts against the seat 23, and the second abutting end 42 abuts against the locking component 3.

For example, as shown in FIG. 4, the tube 231 may be integrally formed with the seat 23 by casting. The tube 231 may be cylindrical and may extend in the left-right direction. The first shaft 5 may be a cylindrical shaft, and may be assembled in the tube 231. Left and right ends of the first shaft 5 may pass through two side plates of the kickstand base 1, respectively. The pivotal assembling of the seat 23 and the kickstand base 1 is achieved by means of the first shaft 5.

The elastic member 4 may be a torsion spring, and the torsion spring may be a symmetrical structure. The torsion spring may include two helical coils, and each helical coil has two ends extending outward. One outward extending end of each helical coil may serve as the first abutting end 41, and the other outward extending ends of the two helical coils may be connected to form the second abutting end 42.

During assembling, the two helical coils may be sleeved onto the outer periphery of the tube 231, one helical coil may be located on a left side of the seat 23, and the other helical coil may be located on a right side of the seat 23. The first abutting end 41 may abut against the seat 23, and the second abutting end 42 may be received by and assembled with the locking component 3. By limiting and constraining the first abutting end 41 and the second abutting end 42, the elastic force of the elastic member 4 may be applied simultaneously to the seat 23 and the locking component 3, thus satisfying the use requirements to keep the locking component 3 engaged with the first engaging portion 21 and the second engaging portion 22, and also satisfying the use requirement to automatically switch the support component 2 to the retracted position.

In some embodiments, the locking component 3 includes a link rod 33 and a load release shaft 34. The link rod 33 is rotatably assembled with the kickstand base 1 via a second shaft 6. The second shaft 6 is located at a middle portion of the link rod 33. One end of the link rod 33 is used to be engaged with the first engaging portion 21 or the second engaging portion 22. The load release shaft 34 is connected to the other end of the link rod 33.

For example, as shown in FIG. 4, the link rod 33 may be a long rod and may generally extend in the front-rear direction, and the second shaft 6 may be a cylindrical shaft. The middle portion of the link rod 33 may have a through hole for the second shaft 6 to pass through. The second shaft 6 is assembled in the through hole, and left and right ends of the second shaft 6 may extend out of two side walls (i.e., side plates) of the kickstand base 1, respectively. This realizes the rotatable assembling of the link rod 33 and the kickstand base 1.

The first engaging projection 31 may be integrally formed on a rear end of the link rod 33, and the second engaging projection 32 may be integrally formed on an outer periphery of the through hole of the link rod 33. A front end of the link rod 33 may have an assembling hole, the load release shaft 34 may be a cylindrical shaft, and the load release shaft 34 may be assembled in the assembling hole of the link rod 33 via interference fit.

When the support component 2 is in the support position, the user may drive the link rod 33 to swing by pressing the load release shaft 34, so that the first engaging projection 31 may be disengaged from the first engaging portion 21. Then, under the action of the elastic member 4, the support component 2 may automatically switch to the retracted position, thus facilitating the switching of the support component 2 from the support position to the retracted position.

In some embodiments, the link rod 33 has a slot 331, and a portion of the elastic member 4 is received in the slot 331. For example, as shown in FIG. 4, the slot 331 may be arranged on a top side of the link rod 33, and an opening of the slot 331 may be arranged to face forward. The second abutting end 42 of the elastic member 4 may be straight-rod-shaped, and the second abutting end 42 may be laterally received in the slot 331, thereby facilitating the connection and assembling of the elastic member 4 and the link rod 33.

A vehicle according to embodiments of the present disclosure is described below.

The vehicle according to the embodiments of the present disclosure includes a vehicle frame and a kickstand mechanism. The kickstand mechanism may be the kickstand mechanism according to any one of the above embodiments. The vehicle may be a two-wheeled electric vehicle, an electric bicycle, or other vehicles that need to be provided with the kickstand mechanism. The kickstand base 1 of the kickstand mechanism is connected to the vehicle frame. For example, the kickstand base 1 may be connected and fixed to the vehicle frame by multiple bolts. In use, the support component 2 and the locking component 3 may swing and be adjusted relative to the kickstand base 1, thus satisfying the use requirements of the support and retraction of the support component 2.

In the kickstand mechanism and vehicle according to the embodiments of the present disclosure, the kickstand mechanism may complete operations with a small force, thus saving effort and improving the overall ease of operations; and in addition, the kickstand mechanism also has a self-locking function to ensure the reliability of a usage state.

In the description of the present disclosure, it should be understood that the orientation or position relationship indicated by terms “center”, “longitudinal”, “transverse”, “length”, “width”, “thickness”, “up”, “down”, “front”, “rear”, “left”, “right”, “vertical”, “horizontal”, “top”, “bottom”, “inner”, “outer”, “clockwise”, “counterclockwise”, “axial”, “radial” and “circumferential” and the like, is based on the orientation or position relationship shown in the accompanying drawings, which is only for the convenience of describing the present disclosure and simplifying the description, and does not indicate or imply that the referred device or element must have a specific orientation, and be constructed and operated in a specific orientation, so it cannot be understood as a limitation of the present disclosure.

In addition, terms “first” and “second” are only used for purpose of description, and cannot be understood as indicating or implying relative importance or implicitly indicating the number of indicated technical features. Therefore, the feature defined as the “first” or the “second” may explicitly or implicitly include at least one such feature. In the description of the present disclosure, “a plurality of” means at least two, such as two, three, etc., unless otherwise specifically defined.

In the present disclosure, unless otherwise expressly defined, terms such as “install/mount”, “interconnect”, “connect”, “fix” shall be understood broadly, and may be, for example, fixed connections, detachable connections, or integral connections; may also be mechanical or electrical connections or intercommunication; may also be direct connections or indirect connections via intervening media; may also be inner communications or interactions of two elements, unless otherwise specifically defined. For those skilled in the art, the specific meaning of the above terms in the present disclosure may be understood according to the specific situations.

In the present disclosure, unless otherwise expressly defined, a first feature “below”, “under”, “on bottom of”, “above”, “on”, or “on top of” a second feature may include an embodiment in which the first feature is in direct contact with the second feature, or the first feature is in indirect contact with the second feature through an intermediate media. And, a first feature “above”, “on”, or “on top of” a second feature may include an embodiment in which the first feature is right or obliquely “above”, “on”, or “on top of” the second feature, or just means that the first feature is at a height higher than that of the second feature. A first feature “below”, “under”, or “on bottom of” a second feature may include an embodiment in which the first feature is right or obliquely “below”, “under”, or “on bottom of” the second feature, or just means that the first feature is at a height lower than that of the second feature.

In the description of the present disclosure, terms such as “an embodiment”, “some embodiments”, “an example”, “a specific example” or “some examples” means that a particular feature, structure, material, or characteristic described in connection with the embodiment or example is included in at least one embodiment or example of the present disclosure. Thus, the appearances of these terms in various places throughout this specification are not necessarily referring to the same embodiment or example of the present disclosure. Furthermore, the particular features, structures, materials, or characteristics may be combined in one or more embodiments or examples in any suitable manner. In addition, without contradiction, those skilled in the art may combine and unite different embodiments or examples or features of the different embodiments or examples described in this specification.

Although the above embodiments have been shown and described, it may be understood that the above embodiments are illustrative and shall not be understood as limitation to the present disclosure, and changes, modifications, alternatives and variations made to the above embodiments by those skilled in the art all fall within the protection scope of the present disclosure.

1. A kickstand mechanism for a vehicle, comprising:
a kickstand base configured to be connected to a vehicle frame of the vehicle;
a support component rotatably connected to the kickstand base and having a support position where the support component bears against the ground and a retracted position where the support component is away from the ground, wherein the support component comprises a first engaging portion and a second engaging portion;
a locking component rotatably connected to the kickstand base, wherein in the support position, the locking component is engaged with the first engaging portion; and in the retracted position, the locking component is engaged with the second engaging portion, wherein the locking component is configured to slide along a surface of the support component and switch from the second engaging portion to the first engaging portion when the support component switches from the retracted position to the support position; and
an elastic member acting on the support component and the locking component, and configured to keep the locking component engaged with the first engaging portion or the second engaging portion, wherein the elastic member is further configured to drive the support component to switch from the support position to the retracted position when the locking component is disengaged from the first engaging portion.

2. The kickstand mechanism according to claim 1, wherein the locking component comprises a first engaging projection; in the support position, the first engaging projection is engaged with the first engaging portion; and in the retracted position, the first engaging projection is engaged with the second engaging portion.

3. The kickstand mechanism according to claim 2, wherein the locking component comprises a second engaging projection, and the first engaging projection and the second engaging projection are arranged at intervals; in the support position, the second engaging projection is disengaged; and in the retracted position, the second engaging projection is engaged with the first engaging portion.

4. The kickstand mechanism according to claim 1, wherein the support component comprises:
a seat rotatably assembled with the kickstand base, and both the first engaging portion and the second engaging portion being arranged on the seat; and
a kickstand bracket connected to the seat.

5. The kickstand mechanism according to claim 4, wherein the kickstand bracket comprises:
a middle section connected to the seat; and
two support sections, wherein the middle section is connected the two support sections, the two support sections are arranged opposite to each other with respect to the middle section, each support section comprises a first sub-section and a second sub-section arranged at an angle relative to each other, and the first sub-section is connected between the middle section and the second sub-section.

6. The kickstand mechanism according to claim 5, wherein the support component comprises a stepping shaft, the stepping shaft is mounted on the second sub-section of one of the two support sections, and the stepping shaft is located on an outer side of the kickstand bracket and extends along a direction in which the two support sections are arranged opposite to each other.

7. The kickstand mechanism according to claim 5, wherein the seat comprises a tube, the seat is rotatably assembled with the kickstand base via a first shaft, the first shaft is assembled in the tube, the elastic member is sleeved on an outer periphery of the tube, the elastic member comprises a first abutting end and a second abutting end, the first abutting end abuts against the seat, and the second abutting end abuts against the locking component.

8. The kickstand mechanism according to claim 1, wherein the locking component comprises:
a link rod rotatably assembled with the kickstand base via a second shaft, wherein the second shaft is located at a middle portion of the link rod, and one end of the link rod is configured to be engaged with the first engaging portion or the second engaging portion; and
a load release shaft connected to the other end of the link rod.

9. The kickstand mechanism according to claim 8, wherein the link rod has a slot, and a portion of the elastic member is received in the slot.

10. A vehicle, comprising a vehicle frame and a kickstand mechanism, wherein the kickstand mechanism comprises:
a kickstand base connected to the vehicle frame;
a support component rotatably connected to the kickstand base and having a support position where the support component bears against the ground and a retracted position where the support component is away from the ground, wherein the support component comprises a first engaging portion and a second engaging portion;
a locking component rotatably connected to the kickstand base, wherein in the support position, the locking component is engaged with the first engaging portion; and in the retracted position, the locking component is engaged with the second engaging portion, wherein the locking component is configured to slide along a surface of the support component and switch from the second engaging portion to the first engaging portion when the support component switches from the retracted position to the support position; and
an elastic member acting on the support component and the locking component, and configured to keep the locking component engaged with the first engaging portion or the second engaging portion, wherein the elastic member is further configured to drive the support component to switch from the support position to the retracted position when the locking component is disengaged from the first engaging portion.

11. The vehicle according to claim 10, wherein the locking component comprises a first engaging projection; in the support position, the first engaging projection is engaged with the first engaging portion; and in the retracted position, the first engaging projection is engaged with the second engaging portion.

12. The vehicle according to claim 11, wherein the locking component comprises a second engaging projection, and the first engaging projection and the second engaging projection are arranged at intervals; in the support position, the second engaging projection is disengaged; and in the retracted position, the second engaging projection is engaged with the first engaging portion.

13. The vehicle according to claim 10, wherein the support component comprises:
a seat rotatably assembled with the kickstand base, and both the first engaging portion and the second engaging portion being arranged on the seat; and
a kickstand bracket connected to the seat.

14. The vehicle according to claim 13, wherein the kickstand bracket comprises:
a middle section connected to the seat; and
two support sections, wherein the middle section is connected the two support sections, the two support sections are arranged opposite to each other with respect to the middle section, each support section comprises a first sub-section and a second sub-section arranged at an angle relative to each other, and the first sub-section is connected between the middle section and the second sub-section.

15. The vehicle according to claim 14, wherein the support component comprises a stepping shaft, the stepping shaft is mounted on the second sub-section of one of the two support sections, and the stepping shaft is located on an outer side of the kickstand bracket and extends along a direction in which the two support sections are arranged opposite to each other.

16. The vehicle according to claim 14, wherein the seat comprises a tube, the seat is rotatably assembled with the kickstand base via a first shaft, the first shaft is assembled in the tube, the elastic member is sleeved on an outer periphery of the tube, the elastic member comprises a first abutting end and a second abutting end, the first abutting end abuts against the seat, and the second abutting end abuts against the locking component.

17. The vehicle according to claim 10, wherein the locking component comprises:
a link rod rotatably assembled with the kickstand base via a second shaft, wherein the second shaft is located at a middle portion of the link rod, and one end of the link rod is configured to be engaged with the first engaging portion or the second engaging portion; and
a load release shaft connected to the other end of the link rod.

18. The vehicle according to claim 17, wherein the link rod has a slot, and a portion of the elastic member is received in the slot.
